(19) United States
(12) Patent Application Publication
(10) Pub. No.: US 2026/0333464 A1
(43) Pub. Date: Oct. 22, 2026

(54) CONFIGURATION FOR A CONTENTION RESOLUTION TIMER

(71) Applicant: Lenovo (United States) Inc., Morrisville, NC (US)

(72) Inventors: Robin Rajan Thomas, Bad Nauheim (DE); Abir Ben Hadj Fredj, Frankfurt (DE); Karthikeyan Ganesan, Nauheim (DE); Ali Ramadan Ali, Kraiburg am Inn (DE)

(73) Assignee: Lenovo (United States) Inc., Morrisville, NC (US)

(21) Appl. No.: 19/321,018

(22) Filed: Sep. 5, 2025

(51) Int. Cl. H04W 74/0833; H04J 13/00; H04W 76/20

(52) U.S. Cl. CPC H04W 74/0841; H04J 13/0062; H04W 76/20

(57) ABSTRACT

Various aspects of the present disclosure relate to a configuration for a contention resolution timer. An apparatus, such as a user equipment (UE), receives a physical random access channel (PRACH) preamble configuration including at least a preamble sequence (e.g., a sequence-spread preamble sequence or a cover-based preamble sequence) and a timer configuration. The UE initiates a timer based on the timer configuration or based on transmission of a preamble. The UE receives a contention resolution message based at least in part on a UE identifier (ID) corresponding to the UE, and the UE performs contention resolution based on the contention resolution message, where the timer is stopped in response to successful completion of the contention resolution.

### TECHNICAL FIELD

The present disclosure relates to wireless communications, and more specifically to a configuration for a contention resolution timer.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a physical random access channel (PRACH) preamble configuration including at least a sequence spread preamble sequence and a timer configuration; initiate a timer based on the timer configuration; receive a contention resolution message based on a UE identifier (ID) corresponding to the UE; and perform contention resolution based on the contention resolution message, where the timer is stopped in response to successful completion of the contention resolution.

A processor (e.g., a standalone processor chipset, or a component of a UE) for wireless communication is described. The processor may be configured to, capable of, or operable to perform one or more operations as described herein. For example, the processor may be configured to, capable of, or operable to receive a PRACH preamble configuration including at least as preamble sequence and a timer configuration; initiate a timer based on the timer configuration; receive a contention resolution message based on a UE ID corresponding to the UE; and perform contention resolution based on the contention resolution message, where the timer is stopped in response to successful completion of the contention resolution.

A method performed or performable by a UE for wireless communication is described. The method may include receiving a PRACH preamble configuration including at least a preamble sequence and a timer configuration; initiating a timer based on the timer configuration; receiving a contention resolution message based on a UE ID corresponding to the UE; and performing contention resolution based on the contention resolution message, where the timer is stopped in response to successful completion of the contention resolution.

In some implementations of the UE, the processor, and the method described herein, a duration of the timer is based on at least one of a duration of a second timer or a duration of a random access response (RAR) window, and where the duration of the timer is defined in slots, subframes, frames, or another time basis. In some implementations of the UE, the processor, and the method described herein, the UE, the processor, and the method may further be configured to, capable of, operable to, performed to, or performable to transmit a preamble, where the timer is initiated in response to transmission of the preamble

In some implementations of the UE, the processor, and the method described herein, the UE, the processor, and the method may further be configured to, capable of, operable to, performed to, or performable to re-transmit the preamble or restart an initial access procedure based on expiration of the timer. In some implementations of the UE, the processor, and the method described herein the preamble is transmitted based on a preamble group mapping.

In some implementations of the UE, the processor, and the method described herein, the contention resolution message is a partial contention resolution message indicating that an NE partially ascertains the UE ID or a full contention resolution message indicating the NE fully ascertains the UE ID. In some implementations of the UE, the processor, and the method described herein, the contention resolution message indicates a temporary cell radio network temporary identifier (TC-RNTI) or a C-RNTI based on a truncated version of the UE ID.

In some implementations of the UE, the processor, and the method described herein, the UE, the processor, and the method may further be configured to, capable of, operable to, performed to, or performable to initiate one or more additional timers associated with one or more sequence-based or cover-based preamble transmissions. In some implementations of the UE, the processor, and the method described herein, the sequence spread preamble sequence includes an m-sequence spread Zadoff-Chu sequence, a third-order polynomial (P3)-sequence spread Zadoff-Chu sequence, or an orthogonal cover code (OCC)-spread Zadoff-Chu sequence.

An NE (e.g., a base station) for wireless communication is described. The NE may be configured to, capable of, or operable to perform one or more operations as described herein. For example, the NE may be configured to, capable of, or operable to transmit a PRACH preamble configuration including at least a preamble sequence and a timer configuration, where a timer is initiated based on the timer configuration; transmit a contention resolution message based on a UE ID; and perform contention resolution based on the contention resolution message, where the timer is stopped in response to successful completion of the contention resolution.

A processor (e.g., a standalone processor chipset, or a component of a NE) for wireless communication is described. The processor may be configured to, capable of, or operable to perform one or more operations as described herein. For example, the processor may be configured to, capable of, or operable to transmit a PRACH preamble configuration including at least a preamble sequence and a timer configuration, where a timer is initiated based on the timer configuration; transmit a contention resolution message based on a UE ID; and perform contention resolution based on the contention resolution message, where the timer is stopped in response to successful completion of the contention resolution.

A method performed or performable by an NE (e.g., a base station) for wireless communication is described. The method may include transmitting a PRACH preamble configuration including at least a preamble sequence and a timer configuration, where a timer is initiated based on the timer configuration; transmitting a contention resolution message based on a UE ID; and performing contention resolution based on the contention resolution message, where the timer is stopped in response to successful completion of the contention resolution.

In some implementations of the NE, the processor, and the method described herein, a duration of the timer is based on at least one of a duration of a second timer or a duration of an RAR window, and where the duration of the timer is defined in slots, subframes, frames, or another time basis. In some implementations of the NE, the processor, and the method described herein, the NE, the processor, and the method may further be configured to, capable of, operable to, performed to, or performable to receive a preamble, where the timer is initiated in response to reception of the preamble.

In some implementations of the NE, the processor, and the method described herein, the NE, the processor, and the method may further be configured to, capable of, operable to, performed to, or performable to receive a retransmission of the preamble based on expiration of the timer. In some implementations of the NE, the processor, and the method described herein, the preamble is received based on a preamble group mapping.

In some implementations of the NE, the processor, and the method described herein, the contention resolution message is a partial contention resolution message indicating that the NE partially ascertains the UE ID or a full contention resolution message indicating the NE fully ascertains the UE ID. In some implementations of the NE, the processor, and the method described herein, the contention resolution message indicates a TC-RNTI or a C-RNTI based on a truncated version of the UE ID.

In some implementations of the NE, the processor, and the method described herein, one or more additional timers are associated, the one or more additional timers associated with one or sequence-based or cover-based preamble transmissions. In some implementations of the NE, the processor, and the method described herein, the preamble sequence includes an m-sequence spread Zadoff-Chu sequence, a P3-sequence spread Zadoff-Chu sequence, or an OCC-spread Zadoff-Chu sequence.

### BRIEF DESCRIPTION OF THE DRAWINGS

FIG. 1 illustrates an example of a wireless communications system in accordance with aspects of the present disclosure.

FIG. 2 illustrates an example of a Long-Term Evolution (LTE) PRACH structure in accordance with aspects of the present disclosure.

FIGS. 3 through 6 illustrate examples of process flows in accordance with aspects of the present disclosure.

FIG. 7 illustrates an example of a preamble selection procedure in accordance with aspects of the present disclosure.

FIG. 8 illustrates an example of collision probabilities based on preamble groups in accordance with aspects of the present disclosure.

FIG. 9 illustrates an example of a process flow in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. UEs may utilize initial access procedures to effectively access a network (e.g., a 3rd Generation Partnership Project (3GPP) network). During initial access, a UE may establish a connection with a network for the first time or after a period of inactivity, for example, if the UE is in a state of low power such as an RRC_IDLE state or an RRC_INACTIVE state. As the demand for multiple UEs increases, there is a need to introduce enhancements to accommodate the increasing number of UEs without substantially increasing the complexity of initial access and other procedures. Such demand may depend on the type of scenario, including the environment and coverage requirements, as well as the type of UEs accessing the network, such as enhanced mobile broadband (eMBB), Internet-of-Things (IoT), and non-terrestrial network (NTN) UEs. The initial access procedures in LTE and New Radio (NR) wireless communications systems are such that coverage and capacity requirements are fulfilled based on the requirements adopted during those generations. Additionally, procedures such as 2-step RACH procedures aim to reduce the latency with which a UE or other wireless device accesses the network.

In some cases, wireless communications systems may lack support for an increase in the number of preambles (i.e., an increase in preamble pool size) to accommodate more users (i.e., UEs) and thus avoid collisions. As described herein, preambles include short sequences transmitted by the UE to identify itself to the network during a RACH procedure. Various methods may be used to increase the number of usable preambles, such as using spreading of Zadoff-Chu sequences based on methods such as m-sequence spreading, third-order polynomial (P3) spreading, or orthogonal cover code (OCC) spreading. Note that aspects of this invention do not preclude the use of other spreading or cover-based methods for a particular preamble sequence design. While each of these methods may increase the preamble pool size, the number of effective usable preambles to avoid collision may depend on various factors such as a normalized average cross correlation, a utilized bandwidth, a sequence spreading length, interference, coverage requirements, and so forth. Additionally, even if the preamble pool size is increased, the additional preambles may not support properties for successful detection at the receiver, such as low cross correlation, zero autocorrelation properties, and so forth. Moreover, subsequent RACH procedures may require updates or enhancements to accommodate the increased number of UEs accessing the network. For example, particular messages may be deemed critical to ensure satisfactory coverage and successful detection at the receiver (e.g., Message 3, etc.) and early identification of the UEs accessing the network.

In some implementations, it may be beneficial to enhance the efficiency of a PRACH or RACH procedure and accommodate a larger preamble pool without affecting the detection performance of the preamble sequence. In some systems, a UE may be uniquely identified in a radio resource control (RRC) connection setup request message (i.e., Message 3) depending on whether the UE is known or unknown to the CN or RAN. It may be beneficial to enable the NE to unambiguously identify the UE early on in a PRACH or RACH procedure, which is important to avoid overload in cases where a large number of UEs are attempting to access the network (e.g., IoT devices, etc.). Additionally, a new timer may be introduced, which may enable the NE to perform partial or full contention resolution after an initial preamble transmission. Techniques are desired to reduce a preamble search space in the case of increased preamble pool sizes via truncated UE ID transmissions during initial access procedures (i.e., a first message transmission) without significantly affecting preamble sequence properties. Note that the reduction of the preamble search space may also be applicable to current/existing preamble pool sizes. Additionally, techniques are desired to ensure preamble grouping based on a family of unique IDs of a particular length, which are associated with a UE. In other implementations, the family of unique IDs may also be applicable to a group of UEs.

To address such limitations, the described techniques provide physical layer behavioral, procedure, and signaling support at the transmitter and receiver to enable enhanced initial access methods. Aspects of the present disclosure are described in the context of a wireless communications system, and include implementations that provide for PRACH enhancements based on preamble groups by enabling a UE and an NE to implicitly or explicitly exchange information that allows an earlier, unambiguous identification of the UE to efficiently perform contention resolution. In some examples, multiple UEs may be grouped into preamble groups based on their respective UE IDs. This may enable a guided and controlled approach by the NE to reduce UE preamble collisions in particular scenarios (e.g., with larger preamble pool sizes while avoiding preamble transmissions or connection failure). Additionally, UE behavior may be specified based on UE ID-based preamble generation to allow for earlier partial or full contention resolution. Additionally, a UE may perform aspects of the UE ID-based preamble generation procedures described herein, subject to UE capability.

In some implementations, a wireless communications system may support an increased (e.g., larger) preamble pool size by supporting group-based preamble selection associated with a UE ID during a first step of a RACH (i.e., initial access) procedure. Additionally, or alternatively, the described techniques support the functionality of UE ID-based preamble generation and UE ID-based preamble generation according to sequence-based spreading. Additionally, or alternatively, the described techniques support a timer that directs UE behavior when awaiting a response to a Message 2 transmission while simultaneously waiting for a contention resolution response from the NE. Additionally, or alternatively, the described techniques support a method that accounts for an additional processing and detection delay of sequence or cover-based preamble sequences for enhanced timer support.

Specifically, a UE may receive a PRACH preamble configuration including at least a preamble group mapping and a UE ID. The preamble group mapping may associate a preamble group with one or more UE IDs or one or more UEs associated with a group ID. Based on the preamble group mapping and at least a portion of the UE ID (e.g., a truncated version of the UE ID), the UE may generate a preamble and transmit the generated preamble. In some examples, the UE may select the preamble from the preamble group based on the UE ID. Additionally, or alternatively, the PRACH preamble configuration may include at least a sequence spread or cover-based preamble sequence and a timer configuration. The UE may initiate a timer based on the timer configuration during a RACH procedure, and receive a contention resolution message based on the UE ID. Based on receiving the contention resolution message, the UE may perform subsequent procedures based on the outcome of the contention resolution accordingly. In some examples, the timer may be stopped in response to successful completion of the contention resolution.

The introduction of a fixed bit signature may assist in increasing a preamble pool size for preamble generation, which may result in easier UE grouping for spreading and cover-based preambles, limiting the preamble search space. Examples of sequence-based spreading may include m-sequence, P3-sequence, or any other type of spreading sequences. Examples of cover-based codes include Walsh-Hadamard binary codes, orthogonal cover codes, discrete Fourier transform (DFT)-based orthogonal codes and so forth. Additionally, enabling the network to configure the UE to use UE ID-based preamble generation may support the reduction of the preamble search space, resulting in decreased latency. Depending on various factors, such as cell load, an NE may configure a set number of preamble groups from which to guide UEs in selecting a specific preamble (e.g., from a specific preamble group), which may further reduce latency and increase throughput. Additionally, configuring a new timer to direct UE behavior when awaiting a message from the NE to perform partial of full contention resolution (e.g., Message 2) may enhance overall PRACH procedures by accommodating a larger number of preambles for increased capacity.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

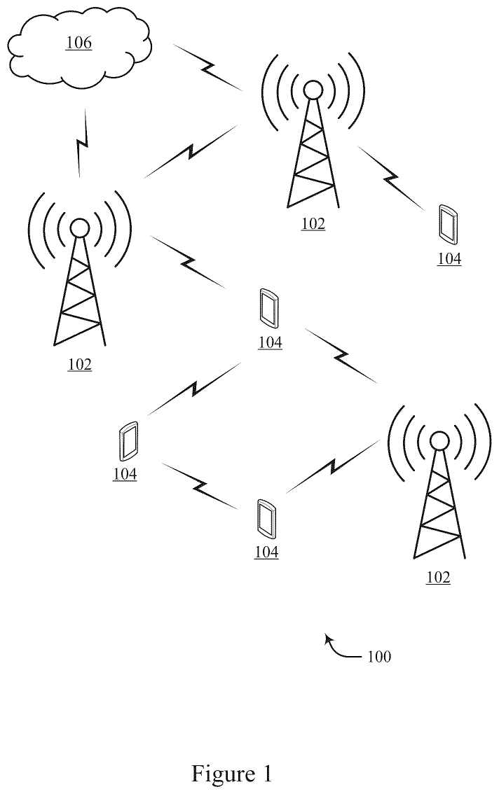

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) and a cyclic prefix (CP). A first numerology (e.g., μ=0) may be associated with a first SCS (e.g., 15 kHz) and a normal CP. In some implementations, the first numerology (e.g., μ=0) associated with the first SCS (e.g., 15 kHz) may utilize one slot per subframe. A second numerology (e.g., μ=1) may be associated with a second SCS (e.g., 30 kHz) and a normal CP. A third numerology (e.g., μ=2) may be associated with a third SCS (e.g., 60 kHz) and a normal CP or an extended CP. A fourth numerology (e.g., μ=3) may be associated with a fourth SCS (e.g., 120 kHz) and a normal CP. A fifth numerology (e.g., μ=4) may be associated with a fifth SCS (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCSs of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 14 symbols. For an extended CP (e.g., applicable for 60 kHz SCS), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first SCS (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS. For example, FR3 may be associated with one or more of the above numerologies.

According to implementations, one or more of the NEs 102 and the UEs 104 are operable to implement various aspects of the techniques described with reference to the present disclosure. For example, a UE 104 receives a PRACH preamble configuration including at least a preamble group mapping and a UE ID. The preamble group mapping may associate a preamble group with one or more UE IDs for multiple IDs. Based on the preamble group mapping and at least a portion of the UE ID (e.g., a truncated version of the UE ID), the UE 104 generates a preamble and transmits the generated preamble. In some examples, the UE 104 selects the preamble from the preamble group based on the UE ID. Additionally, or alternatively, the PRACH preamble configuration may include at least a preamble sequence (e.g., a sequence-spread preamble sequence or a cover-based preamble sequence) and a timer configuration. The UE 104 may initiate a timer based on the timer configuration during a RACH procedure, and receive a contention resolution message based on the UE ID. Based on receiving the contention resolution message, the UE 104 may perform contention resolution accordingly. In some examples, the timer may be stopped in response to successful completion of the contention resolution.

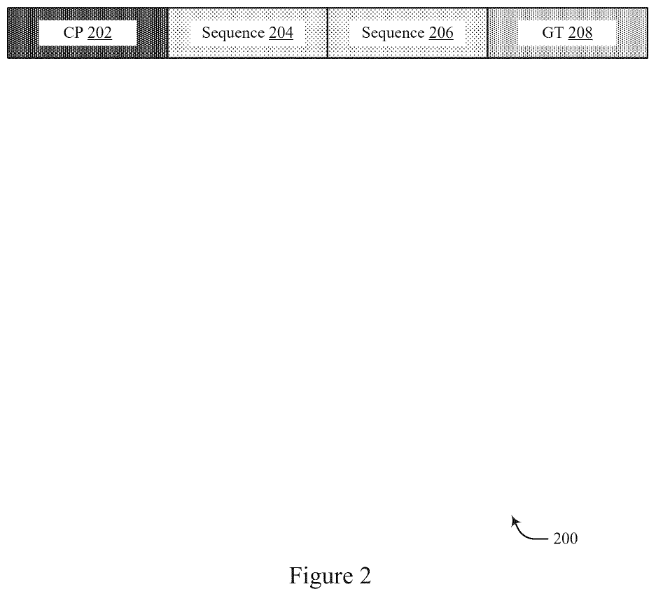

FIG. 2 illustrates an example of an LTE PRACH structure 200 in accordance with aspects of the present disclosure. The LTE PRACH structure 200 may be an example of a general structure of an LTE preamble. Four main preamble formats are supported in LTE, including format 0, format 1, format 2, and format 3. In addition, a format 4 is designed for LTE TDD in small cells with a 5 kHz SCS. Common characteristics may include a 1.25 kHz narrower SCS (e.g., longer symbol durations for larger cell sizes) and Zadoff-Chu sequences with a length of 839 for better correlation and larger coverage and frequency resource allocation of 6 physical resource blocks (PRBs) (e.g., approximately 1.08 MHz).

An LTE preamble format may generally include a CP 202, a sequence 204, a sequence 206, and a guard time (GT) 208. An LTE preamble format 0 may be suitable for small to medium cells (up to approximately 14 km) with a 1 ms (1 subframe) random access bust and an 800 μs preamble sequence. Use cases may include LTE re-farming and conventional macro deployments. An LTE preamble format 1 may be designed for larger cells (up to approximately 77 km) with a 2 ms (2 subframe) random access burst and an 800 μs preamble sequence. The format 1 may have a longer CP and a longer GT compared to format 0, but still may utilize a single Zadoff-Chu sequence. Use cases include rural areas and remote deployments. An LTE preamble format 2 may be designed for very large cells (up to approximately 29.5 km), with a 3 ms (3 subframe) random access burst and a 1600 μs preamble sequence. The robustness of the format 2 may be enhanced by repeating a Zadoff-Chu sequence twice within a preamble and by having a shorter CP and a shorter GT than the format 1. Use cases include challenging environments and coverage extension. An LTE preamble format 3 may be designed for very large cells (up to approximately 100 km), with a 3 ms (3 subframe) random access burst and a 1600 μs preamble sequence. The format 3 combines the features of format 1, including a long CP and a long GP, and format 2, including two repetitions of the sequence, which may increase the robustness of format 3. An LTE preamble format 4 may be used specifically for LTE TDD and special subframes in small cells (up to approximately 4.4 km). The format 4 uses a short sequence length (e.g., 139 with a 7.5 kHz SCS).

In NR wireless communications, different PRACH preamble formats may be used for a variety of coverage scenarios. In total, there are thirteen preamble formats, which may be categorized into long sequences and short sequences. The long sequences inherit the structure of the LTE preamble formats 0, 1, 2, 3, and 4, while the short sequences include formats A1, A2, A3, B1, B2, B3, B4, C0, and C2, and additionally, some mixed format combinations, A1/B1, A2/B2, or A3/B3, within a RACH occasion, which includes specific time-frequency resources allocated for RACH transmissions. Format 3 may support a 5 kHz SCS, which is different compared to LTE for higher doppler resiliency. Table 1 summarizes the long sequence preamble formats for a sequence length (L_{RA}=839) and Table 2 summarizes the short sequence preamble formats for various sequence lengths.

TABLE 1
Long sequence preamble formats for L_{RA} = 839

| | | | Sequence | | | | |
|---|---|---|---|---|---|---|---|
| | | CP | Length | Guard | | | |
| | | duration | Duration | Time | | | |
| | | (Ts = | (Ts = | (Ts = | | Max Cell | Supported |
| | SCS | 1/(15 kHz × | 1/(15 kHz × | 1/(15 kHz × | No. | Duration | Restricted |
| Format | (kHz) | 2048) | 2048) | 2048) | of SF | (m) | Sets |
| 0 | 1.25 | 3168 × Ts | 24576 × Ts | 2976 × Ts | 1 | 14500 | Unrestricted, |
| | | | | | | | Type A, |
| | | | | | | | Type B |
| 1 | 1.25 | 21024 × Ts | 2 rep × | 15840 × Ts | 2 | 77300 | Unrestricted, |
| | | | 24576 × | | | | Type A, |
| | | | Ts | | | | Type B |
| 2 | 1.25 | 4688 × Ts | 2 rep × | 6048 × Ts | 2 | 29500 | Unrestricted, |
| | | | 24576 × | | | | Type A, |
| | | | Ts | | | | Type B |
| 3 | 5 | 21024 × Ts | 2 rep × | 24576 × Ts | 3 | 101900 | Unrestricted, |
| | | | 24576 × | | | | Type A, |
| | | | Ts | | | | Type B |

TABLE 2
Short sequence preamble formats

| | | | | | Sequence | | |
|---|---|---|---|---|---|---|---|
| | | | | CP | Length | | |
| | Sequence | Sequence | | duration | Duration | | |
| | Length | Length | Sequence | (Ts = 1/(15 | (Ts = 1/(15 | | |
| | (L_{RA}) = | (L_{RA}) = | Length | kHz × 204 | kHz × 2048) | Guard | |
| | 139 | 1151 | (L_{RA}) = | κ = Tₛ/T_{c} | κ = Tₛ/T_{c} | Time | Cell |
| | SCS | SCS | 571 | (Ts = 1/(480 | (Ts = 1/(480 | (Ts = 1/(15 | Radius |
| Format | (kHz) | (kHz) | SCS (kHz) | kHz × 4096)8) | kHz × 4096) | kHz × 2048) | (m) |
| A1 | 15/30/60/120 | 15/120 | 30/120/480 | 288κ · 2^{-μ} | 2 · 2048κ · 2^{-μ} | 6-10 | 1-5 |
| | | | | | | μs | km |
| A2 | 15/30/60/120 | 15/120 | 30/120/480 | 576κ · 2^{-μ} | 4 · 2048κ · 2^{-μ} | Varies | 2-10 |
| | | | | | | with | km |
| | | | | | | SCS | |
| A3 | 15/30/60/120 | 15/120 | 30/120/480 | 864κ · 2^{-μ} | 6 · 2048κ · 2^{-μ} | Varies | 5-20 |
| | | | | | | with | km |
| | | | | | | SCS | |
| B1 | 15/30/60/120 | 15/120 | 30/120/480 | 216κ · 2^{-μ} | 2 · 2048κ · 2^{-μ} | Varies | 5-20 |
| | | | | | | with | km |
| | | | | | | SCS | |
| B2 | 15/30/60/120 | 15/120 | 30/120/480 | 360κ · 2^{-μ} | 4 · 2048κ · 2^{-μ} | Varies | Similar |
| | | | | | | with | to A |
| | | | | | | SCS | formats |
| B3 | 15/30/60/120 | 15/120 | 30/120/480 | 504κ · 2^{-μ} | 6 · 2048κ · 2^{-μ} | Varies | Similar |
| | | | | | | with | to A |
| | | | | | | SCS | formats |
| B4 | 15/30/60/120 | 15/120 | 30/120/480 | 936κ · 2^{-μ} | 12 · 2048κ · 2^{-μ} | Varies | Similar |
| | | | | | | with | to A |
| | | | | | | SCS | formats |
| C0 | 15/30/60/120 | 15/120 | 30/120/480 | 1240κ · 2^{-μ} | 2048κ · 2^{-μ} | Fixed | Shorter |
| | | | | | | | ranges |
| C2 | 15/30/60/120 | 15/120 | 30/120/480 | 2048κ · 2^{-μ} | 4 · 2048κ · 2^{-μ} | Fixed | Shorter |
| | | | | | | | ranges |

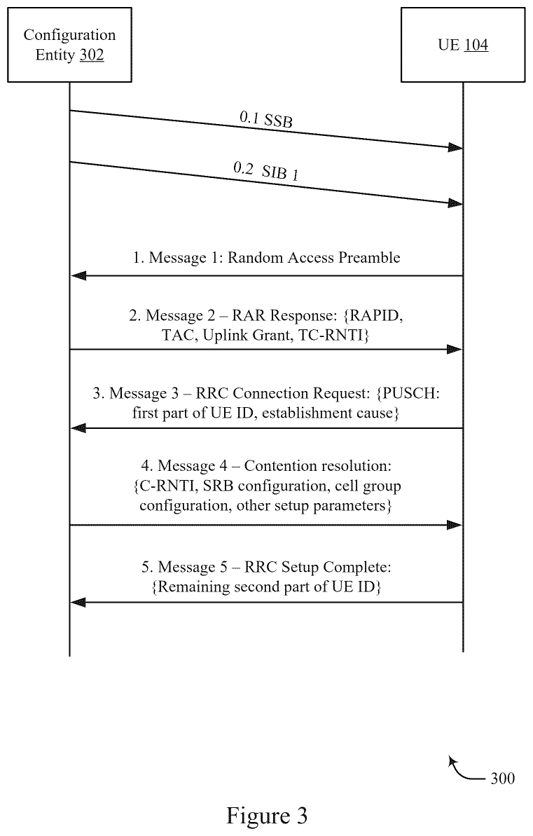

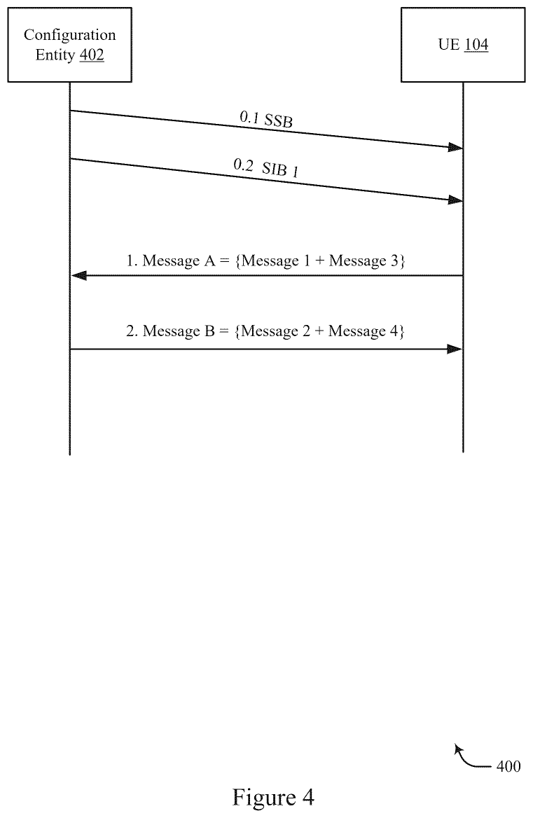

FIG. 3 illustrates an example of a process flow 300 in accordance with aspects of the present disclosure. In a wireless communication system, synchronization may be categorized as downlink synchronization or uplink synchronization. A UE 104 may achieve downlink synchronization by successfully decoding minimum system information (i.e., a synchronization signal block (SSB)-master information block (MIB)) and remaining system information (RMSI) (i.e., an RMSI-SIB1). After decoding a system information block (SIB) (e.g., a SIB1 message), the UE 104 may have the necessary information to begin uplink synchronization. Uplink synchronization involves aligning the UE's timing with the network's timing to ensure efficient and reliable uplink communication. This second part of the process is referred to as a RACH procedure, which may be a 4-step, contention-based process used for initial network access, or a lower latency 2-step procedure. Contention-based RACH (CBRA) is a RACH procedure including contention-based initial access, where multiple UEs may attempt to access the network simultaneously using the same or different preambles, where the selection of same preambles lead to collisions. Contention-free RACH (CFRA) is a RACH procedure where the network allocates an assigned preamble over specific resources to a UE, ensuring that no collisions occur. The process flow 300 illustrates an example of a 4-step RACH procedure, and a process flow 400 described herein with reference to FIG. 4 illustrates an example of a 2-step RACH procedure, which may be associated with contention-based initial access.

The 4-step RACH procedure depicted by the process flow 300 may be between a configuration entity 302 (e.g., a RAN, an NE, a base station, a gNB) and a UE 104. At step 0.1, the UE 104 may receive an SSB from the configuration entity 302. For example, the SSB may be an SSB-MIB including minimum system information. At step 0.2, the UE 104 may receive an SIB1 from the configuration entity 302. For example, the SIB1 may be an RMSI-SIB1.

At step 1, the UE 104 may transmit a Message 1 to the configuration entity 302. The Message 1 may be a random access preamble. At step 2, the UE 104 may receive a Message 2 from the configuration entity 302. The Message 2 may be an RAR message, which may include at least one of a random access preamble ID (RAPID), a timing advance command (TAC), an uplink grant, or a TC-RNTI.

At step 3, the UE 104 may transmit a Message 3 to the configuration entity 302. The Message 3 may be an RRC connection request transmitted via a physical uplink shared channel (PUSCH). In some examples, the Message 3 may include at least a first part of a UE ID (corresponding to the UE 104) and an establishment cause.

At step 4, the UE 104 may receive a Message 4 from the configuration entity 302. The Message 4 may be a contention resolution message, which may include at least one of a C-RNTI, a signaling radio bearer (SRB) configuration, a cell group configuration, or other setup parameters.

At step 5, the UE 104 may transmit a Message 5 to the configuration entity 302. The Message 5 may be an RRC setup complete message, which may include a remaining second part of the UE ID.

FIG. 4 illustrates an example of a process flow 400 in accordance with aspects of the present disclosure. As described herein with reference to FIG. 3, a wireless communication system, synchronization may be categorized as downlink synchronization or uplink synchronization. A UE 104 may achieve downlink synchronization by successfully decoding minimum system information (i.e., an SSB-MIB) and remaining system information (RMSI) (i.e., an RMSI-SIB1). After decoding an SIB1 message, the UE 104 may have the necessary information to begin uplink synchronization. This second part of the process is referred to as a RACH procedure, which may be a 4-step, contention-based process used for initial network access, or a lower latency 2-step procedure. The process flow 400 illustrates an example of a 2-step RACH procedure, and a process flow 300 described herein with reference to FIG. 3 illustrates an example of a 4-step RACH procedure.

The 2-step RACH procedure depicted by the process flow 400 may be between a configuration entity 402 (e.g., a RAN, an NE, a base station, a gNB) and a UE 104. At step 0.1, the UE 104 may receive an SSB from the configuration entity 402. For example, the SSB may be an SSB-MIB including minimum system information. At step 0.2, the UE 104 may receive an SIB1 from the configuration entity 402. For example, the SIB1 may be an RMSI-SIB1.

At step 1, the UE 104 may transmit a Message A to the configuration entity 402. The Message A may be equivalent to the Message 1 and the Message 3 of the 4-step RACH procedure described herein with reference to FIG. 3, where the Message 1 may be a random access preamble, and the Message 3 may be an RRC connection request. In some examples, the Message A may include at least a first part of a UE ID (corresponding to the UE 104) and an establishment cause.

At step 2, the UE 104 may receive a Message B from the configuration entity 402. The Message B may be equivalent to the Message 2 and the Message 4 of the 4-step RACH procedure described herein with reference to FIG. 3, where the Message 2 may be an RAR, and the Message 4 may be a contention resolution message. As such, the Message B may include at least one of a RAPID, a TAC, an uplink grant, or a TC-RNTI, in addition to at least one of a C-RNTI, an SRB configuration, a cell group configuration, or other setup parameters.

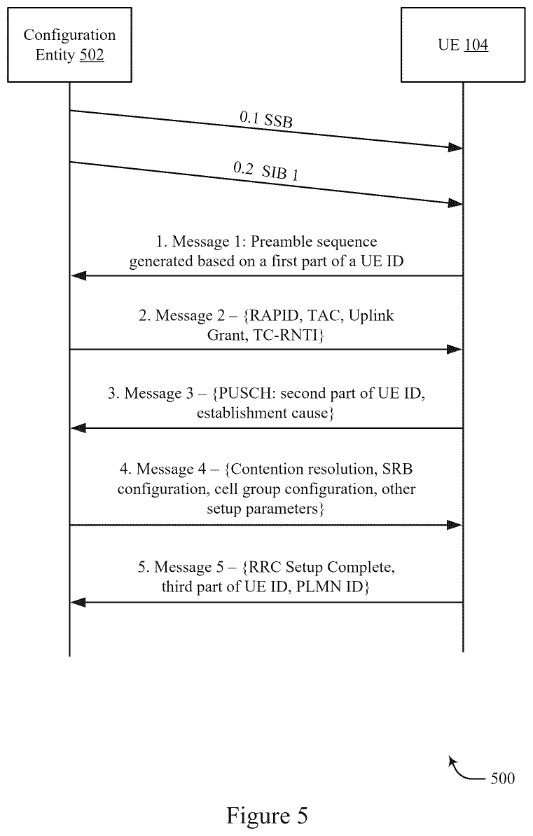

FIG. 5 illustrates an example of a process flow 500 in accordance with aspects of the present disclosure. The process flow 500 illustrates an example of a 4-step RACH procedure performed by a configuration entity 502 (e.g., a RAN, an NE, a base station, a gNB) and a UE 104, and enabled with UE ID-based preamble generation. In some implementations, the process flow 500 may support an increased number of preambles for increased capacity (e.g., an increased number of UEs performing initial access).

In some implementations, an NE (e.g., the configuration entity 502) and the UE 104 may support one or a combination of techniques, which support an increased number of preambles by supporting group-based preamble selection associated with a UE ID during the first step of a RACH (initial access) procedure, such as the 4-step RACH procedure illustrated in the process flow 500. Additionally, the NE and the UE 104 may support various functionalities of UE ID-based preamble generation, which may be based on sequence-based or cover-based spreading. Additionally, or alternatively, the NE and the UE 104 may support a timer used to direct UE behavior when awaiting a response to a Message 2 while also simultaneously waiting for a contention resolution response from the network. In some cases, the additional processing delay of sequence-based or cover-based preamble sequences may be taken into account to further enhance usage of the timer. Aspects of the techniques described herein are described with respect to the 5G RAN architecture and physical layer for illustrative purposes. Such techniques may be applied to any potential radio access technologies beyond 5G, for example, 6G, with similar or equivalent functionality stemming from the described components, features, and procedures.

The process flow 500 may support procedures to enhance PRACH transmissions to support increased user density and thus overall capacity, while avoiding collisions. In some implementations, at least part of a unique UE ID may be used to generate a UE preamble to minimize the risk of collisions in contention-based scenarios and to distinguish between same or different preambles at the receiver side. In some cases, a part or portion of the total UE ID may be selected to obtain a careful tradeoff between introducing additional overhead, and the ability to avoid collisions. The part or portion of the UE ID, for example, a truncated version of the UE ID, may be derived from either one of a CN ID or a RAN ID. The CN ID may include a globally unique ID (GUTI), such as a 6G global unique MME ID (GUMMEI) (e.g., an octet or multiple thereof, e.g., 64 bits) or a 6G temporary mobile subscriber identity (TMSI) (e.g., an octet or multiple thereof, e.g., 32 bits), a subscriber permanent ID (SUPI) (e.g., 120 to 128 bits depending on the format), a 6G shortened-TMSI ID (S-TMSI ID) (e.g., total length 48 bits), or a combination thereof. The RAN ID may further include a cell level identification of a UE in the form of a C-RNTI, a TC-RNTI, a resume ID (e.g., also referred to as a short inactive-RNTI (I-RNTI)), or a combination thereof. That is, the UE ID may be a global ID or a local ID based on a CN ID, a RAN UE Id, or both. In some implementations, a fixed n-bit random value may be used to generate a preamble transmission, where n may be a truncated number of bits of a total random m-bit ID. Exemplary conditions may include the unavailability of any of the CN-level or RAN-level IDs. In some other cases, the use of such IDs may vary depending on the state or mode of the UE (e.g., RRC_IDLE or RRC_INACTIVE).

In some implementations, Zadoff-Chu sequences are preamble sequence designs used in LTE and NR systems due to their constant amplitude zero auto-correlation and low, fixed cross-correlation properties. Zadoff-Chu sequences have benefits in terms of low peak-to-average power ratio (PAPR) (e.g., Zadoff-Chu sequences have the property of constant envelope) and good characteristics of cross-correlation and autocorrelation. Additionally, the preamble sequence design adopted in LTE systems is robust in terms of the selection of preamble root sequences and the mapping from a logical root sequence to a physical root sequence of a Zadoff-Chu sequence, which may reduce the effort of standardization and impact on product implementation. The preamble sequence design for 5G wireless communications systems and radio access technologies beyond 5G, for example, 6G, may continue to use Zadoff-Chu sequences as a reliable sequence design.

The wireless communications system may support a number of preambles (i.e., a PRACH capacity) in a RACH procedure. A common pool of preambles may be supported for each cell. For example, for LTE and NR, 64 preambles may be available for UE generation and selection (e.g., contention-based) or assigned by an NE (e.g., contention-free). However, given an expected increase in the number of devices from different applications performing initial access (e.g., eMBB, IoT, or NTN devices), the current 64-preamble allocation or pool per cell may be constrained or limited, leading to a higher number of collisions and thus low quality of network experience for the user. To increase the preamble pool, while continuing to maintain the good orthogonal structural properties of Zadoff-Chu preamble design, additional preamble sequence spreading or cover design formats may be used, including m-sequence spread Zadoff-Chu sequences, time or frequency spread OCC Zadoff-Chu sequences (i.e., masked Zadoff-Chu sequences), and P3-spread Zadoff-Chu sequences. Additional preambles generated by such cover codes or designs may increase the preamble pool size per cell at the cost of additional complexity when compared to a pure Zadoff-Chu preamble design. By way of example, the following Zadoff-Chu preamble sequence frequency-domain generation expression for n preambles as a function of root indices may be utilized to increase the preamble pool:

$${y}_{u , v} ( n ) = {\sum }_{m = 0}^{{L}_{R A} - 1} {x}_{u , v} ( n ) \cdot {e}^{- j \frac{2 π m n}{{L}_{R A}}} ,$$

where x_{u,v}(n)=xᵤ((n+Cᵥ)mod L_{RA}) and

$${x}_{u} ( i ) = {e}^{- j \frac{2 π m n}{{L}_{R A}}} , i = 0 , 1 , … , {L}_{R A} - 1 ,$$

and where u may represent a sequence number, Cᵥ may represent a number of cyclic shifts, L_{RA} may represent a sequence length and the relationship between the logical index, and i and the sequence number u is defined according to different mapping tables. Additionally, one base or root sequence may be assigned per cell, for example, via broadcast signaling (e.g., SIB1) to be used amongst all UEs.

In some implementations, a truncated UE ID, given by

$${n}_{U E}^{ID} ,$$

may be used to generate a given number or orthogonal preambles. This also enables the generated preambles to be distinguished based on the UE ID. In some examples, UEs within a cell may be enabled or configured to utilize their own n_{UE} ^{ID} to generate the preamble via a flag. This may be enabled if the UE is registered in the current public land mobile network (PLMN). Otherwise, the UE may generate a random or pseudo-random number as part of the UE ID to generate the preamble. Table 3 depicts the PRACH preamble configuration a UE may receive from the network in order to enable UE ID-based preamble generation.

TABLE 3
PRACH preamble configuration

| Parameter | Value | Description |
|---|---|---|
| > SIB 1 | | Carries the configuration |
| | | related to initial access, cell |
| | | selection, access control, SI |
| | | request information, other |
| | | system information, and so |
| | | forth |
| >>totalNumberOfRAPreambles | INTEGER {1, . . . , M} | Preamble Pool size |
| >> RACH-ConfigCommon | | Configuration of cell specific |
| | | random access parameters |
| | | which the UE uses for |
| | | contention-based and |
| | | contention-free random access |
| | | as well as for contention based |
| | | beam failure recovery in this |
| | | bandwidth part (BWP). |
| >>>RACH-ConfigGeneric | | RACH parameters for |
| | | performing a random access |
| | | procedure on a candidate cell. |
| >>>>PRACH- | Integer {0, . . . , 255} | PRACH configuration index. |
| Configuration-Index | | |
| >>>>Msg1-FDM | Enumerated {1, 2, 4, 8} | The number of PRACH |
| | | transmission occasions |
| | | FDMed in one time instance |
| >>>>Msg1-CDM | Enumerated {1, . . . , | The number of PRACH |
| | maxCDMvalue} | transmission occasions |
| | | CDMed in one time instance |
| | | on the same time-frequency |
| | | resources via choice of cover |
| | | codes or spreading sequences |
| | | up to a maximum number of |
| | | CDM. |
| >>>>Msg1- | Integer (0, . . . , | Offset of lowest PRACH |
| FrequencyStart | maxNrofPRBs) | transmission occasion in |
| | | frequency domain with |
| | | respective to PRB 0. The value |
| | | is configured so that the |
| | | corresponding RACH resource |
| | | is entirely within the |
| | | bandwidth of the UL BWP. |
| >>>>zeroCorrelation | Integer {0, . . . , 15} | Determines the N_{CS} (cyclic |
| ZoneConfig | | shift spacing between |
| | | preambles to maintain |
| | | preamble orthogonality) |
| >>>>preambleRe- | Integer {−202, . . . , −60} | The target power level at the |
| ceivedTargetPower | | network receiver side |
| >>>>Additional | . . . | . . . |
| parameters | | |
| >>> UE-ID | Choice {True, False} | Determines whether UE |
| | | includes UE ID (n_{UE}^{ID}) as part |
| | | of the preamble generation |
| | | procedure for any of the |
| | | preamble formats. The UE ID |
| | | may be a truncated part of the |
| | | total ID, e.g., MSB or LSB, or |
| | | in other implementations the |
| | | total ID may be used. If not |
| | | available, a random UE ID |
| | | may be generated according |
| | | the specified length/size limit |
| | | of this UE ID. |
| >>> UE-ID-Trunc-Size | Bits | Determines the amount of bits |
| | | of the total UE ID that are to |
| | | be truncated, e.g., MSB or |
| | | LSB. |
| >>> UE-ID-Group-ID | INTEGER {0, . . . , | Mapping which determines the |
| | maxUEGroups} | UE grouping according to |
| | | MSB or LSB of (n_{UE}^{ID}) |
| | | depending on the size of n_{UE}^{ID}. |
| | | The number of groups and size |
| | | of n_{UE}^{ID} can be determined |
| | | based on various factors, e.g., |
| | | load of the cell or number of |
| | | UEs registered in network. A |
| | | preamble group ID is used to |
| | | distinguish different preamble |
| | | groups. |
| >>>PRACH- | Integer{0, | PRACH root sequence index |
| RootSequenceIndex | maxSequenceIndex} | The value range depends on |
| | | the Sequence length, e.g., |
| | | L = 839, L = 139, L = 571 or |
| | | L = 1151. |
| | | Different values can be |
| | | considered depending on FR1, |
| | | FR2 and FR3 depending on |
| | | the used SCS. |
| >>>restrictedSetConfig | Enumerated {unrestrictedSet, | Configuration of an |
| | restrictedSetTypeA, | unrestricted set or one of two |
| | restrictedSetTypeB} | types of restricted sets |

In some examples, the PRACH preamble configuration as detailed in Table 3 may include an indication to generate the preamble based on enabling UE ID-based preamble generation and selection. For example, the parameter UE-ID with a value of {True, False} may indicate whether UE includes the UE ID

$$( e . g . , {n}_{U E}^{ID} )$$

as part of the preamble generation procedure for any of the preamble formats if True and if False, may generate the preamble according to the normal preamble procedures, e.g., 6GR preamble procedures. The UE ID may be a truncated based on part of the full UE ID. If the UE-ID related parameters are excluded from the PRACH preamble configuration, then a random UE ID may be generated according to a specified length or size limit of the UE ID. Additionally, or alternatively, the PRACH preamble configuration may include the preamble group mapping. The preamble group mapping may be given by a parameter UE-ID-Group-ID with an integer value {0, . . . , maxUEGroups}. The preamble group mapping may determine a UE grouping according to an MSB or an LSB of the UE ID

$$( e . g . , {n}_{U E}^{ID} )$$

depending on the size of

$${n}_{U E}^{ID} .$$

The number of groups and size of

$${n}_{U E}^{ID}$$

may be determined based on the load of the cell or number of UEs registered in the network. A preamble group ID may be used to distinguish different preamble groups. Additionally, or alternatively, the PRACH preamble configuration may indicate the portion of the UE ID, or truncation information that implicitly indicates the portion of the UE ID. For example, the PRACH preamble configuration may include a parameter, UE-ID-Trunc-Size, which may include a number of bits indicative of the amount of bits of the full UE ID that are truncated.

In some implementations, the UE ID may add another distinguishing feature to avoid preamble collision at the network receiver, when one or more UEs select the same preamble for transmission on the identical PRACH occasion. The probability of collision increases as more UEs attempt to perform initial access. The addition of the UE ID enables a deterministic method to control the preamble generation process to lower the probability of collisions.

In the example of the process flow 500, the configuration entity 502 and the UE 104 may perform a 4-step RACH procedure enabled with UE ID-based preamble generation. At step 0.1, the UE 104 may receive an SSB from the configuration entity 502. For example, the SSB may be an SSB-MIB including minimum system information. At step 0.2, the UE 104 may receive an SIB1 from the configuration entity 502. For example, the SIB1 may be an RMSI-SIB1.

At step 1, the UE 104 may transmit a Message 1 to the configuration entity 502. The Message 1 may include a sequence generated based on a first part or portion of a UE ID (e.g., a truncated version of the UE ID). At step 2, the UE 104 may receive a Message 2 from the configuration entity 502. The Message 2 may be an RAR including at least one of a RAPID, a TAC, an uplink grant, or a TC-RNTI.

At step 3, the UE 104 may transmit a Message 3 to the configuration entity 502. The Message 3 may be an RRC connection request transmitted via a PUSCH. In some examples, the Message 3 may include at least a second part or portion of the UE ID and an establishment cause.

At step 4, the UE 104 may receive a Message 4 from the configuration entity 502. The Message 4 may be a contention resolution message, which may include at least one of a C-RNTI, an SRB configuration, a cell group configuration, or other setup parameters.

At step 5, the UE 104 may transmit a Message 5 to the configuration entity 502. The Message 5 may be an RRC setup complete message, which may include a remaining, third part or portion of the UE ID and a PLMN ID.

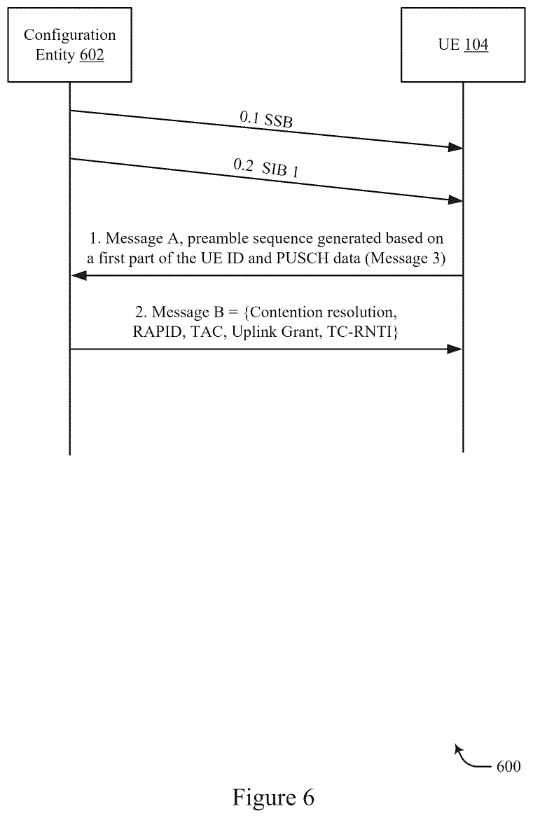

FIG. 6 illustrates an example of a process flow 600 in accordance with aspects of the present disclosure. The process flow 600 illustrates an example of a 2-step RACH procedure performed by a configuration entity 602 (e.g., a RAN, an NE, a base station, a gNB) and a UE 104, and enabled with UE ID-based preamble generation. In some implementations, the process flow 600 may support an increased number of preambles for increased capacity (e.g., an increased number of UEs performing initial access).

As described herein with reference to FIG. 6, the process flow 600 may support procedures to enhance PRACH transmissions to support increased user density and thus overall capacity, while avoiding collisions. In the 2-step RACH procedure depicted by the process flow 600, at step 0.1, the UE 104 may receive an SSB from the configuration entity 602. For example, the SSB may be an SSB-MIB including minimum system information. At step 0.2, the UE 104 may receive an SIB1 from the configuration entity 602. For example, the SIB1 may be an RMSI-SIB1.

At step 1, the UE 104 may transmit a Message A to the configuration entity 602. The Message A may be equivalent to the Message 1 and the Message 3 of the 4-step RACH procedure described herein with reference to FIG. 3, where the Message 1 may include a preamble sequence generated based on a first part or portion of a UE ID, and the Message 3 may include PUSCH data.

At step 2, the UE 104 may receive a Message B from the configuration entity 602. The Message B may include a contention resolution message with at least one of a RAPID, a TAC, an uplink grant, or a TC-RNTI.

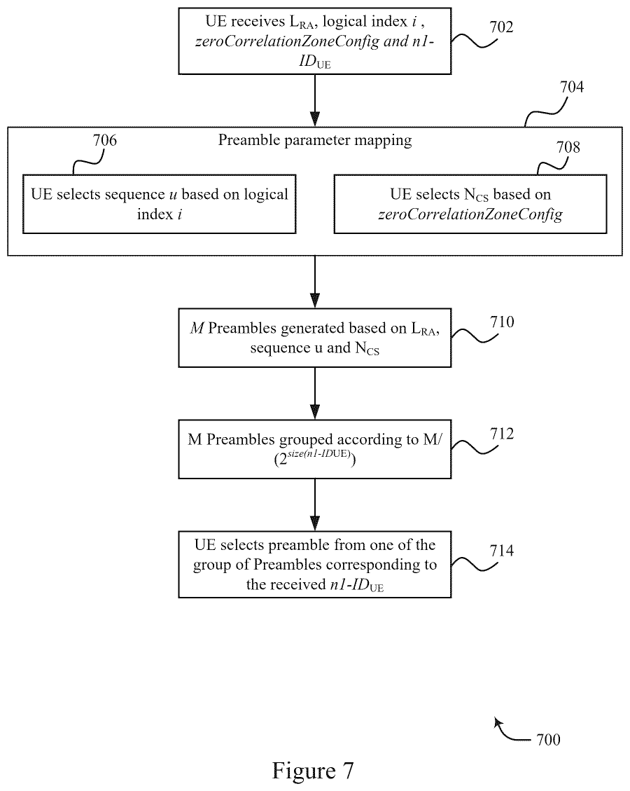

FIG. 7 illustrates an example of a preamble selection procedure 700 in accordance with aspects of the present disclosure. In this example, the preamble selection procedure 700 may be based on UE ID groupings.

As described herein with reference to FIG. 5, a truncated UE ID, given by

$${n}_{U E}^{ID} ,$$

may be used to generate a given number or orthogonal preambles. That is, the generated preambles may be distinguished based on a UE ID. To generate preambles based on

$${n}_{U E}^{ID} ,$$

the UE may receive a logical index, i, via a PRACH-RootSequenceIndex information element (IE). The PRACH-RootSequenceIndex IE may depend on a sequence length, L_{RA}, to select a sequence number, u. The UE may then determine a cyclic shift spacing, N_{CS}, depending on a received zeroCorrelationZoneConfig parameter. The UE may generate M≤64 preambles according to the logical index i, L_{RA}, N_{CS}, and u. If M<64, the next consecutive logical index i with a corresponding u may be selected until a total of 64 preambles are generated. The UE may randomly select one out of the 64 generated preambles for transmission in a given PRACH occasion, or the UE may select the preamble based on some selection criteria.

In some implementations, a probability of collision, P(collision), of M preambles for k users (i.e., UEs) in a given PRACH occasion may be given as

$$P ( collision ) = 1 - P ( no\_collision ) = 1 - \frac{M !}{{M}^{k} \times ( M - 1 ) !} .$$

Assuming M=64 preambles and k users (i.e., UEs), Table 4 depicts the probability of collision for different numbers of UEs selecting overlapping preambles based on a legacy preamble strategy. An association may be derived based on the

$${n}_{U E}^{ID}$$

preamble grouping and the parameters for Zadoff-Chu sequence generation, the logical index i, L_{RA}, N_{CS}, and u, such that a reduced search space is created based on a subset of parameters associated with a particular UE group. In this example, the total preamble size (M) may be partitioned into

$${2}^{n {1}_{U E}^{ID}}$$

UE groups, where the group association to preamble parameters (e.g., i, L_{RA}, N_{CS}, and u) is known both to the UE (e.g., preamble transmitter) and the NE (e.g., preamble receiver).

TABLE 4
Probability of collision for k users selecting
same preamble on same PRACH occasion

| | Probability of collision |
|---|---|
| Number of users (UEs) | (Legacy) M = 64 |
| 2 | 1.56% |
| 10 | 52.32% |
| 20 | 96.41% |

Based on the number of UEs occupying a cell, preambles may be partitioned into groups defined by

$$n {1}_{U E}^{ID} .$$

Instead of the UE randomly selecting one out of M total preambles for transmission in a given PRACH occasion, the

$$n {1}_{U E}^{ID}$$

may provide further guidance on which specific group of preambles is to be selected based on the UE ID preamble group. The NE and the UE may maintain an association or mapping between the preamble groups and the

$$n {1}_{U E}^{ID}$$

groups (e.g., a preamble group mapping). In addition, the NE may create a mapping between the preamble groups and the UE IDs based on various factors, such as the perceived load of the cell, a number of UEs registered in the network, and so forth. The preamble generation parameters, such as i, L_{RA}, N_{CS}, and u, may be used to determine the number of preambles that may be generated up to M preambles. Thereafter, the UE may randomly select the appropriate preambles within its own group of preambles associated with its own

$$n {1}_{U E}^{ID} .$$

### If the

$$n {1}_{UE}^{ID}$$

is absent from a configuration from the NE, the UE may select one out of M total preambles as a fallback. An example illustration of such a procedure is detailed in the preamble selection procedure 700.

At 702, the UE may receive a sequence length, L_{RA}, a logical index, i, a zeroCorrelationZoneConfig parameter, and a UE ID,

$$n {1}_{UE}^{ID} .$$

At 704, based on such information, the UE may generate a preamble parameter mapping. The value of L_{RA} may be 139, 839, 571, 1157 or any other compatible coprime number. At 706, the UE may select a sequence u based on the logical index i, and at 708, the UE may select a cyclic shift spacing, N_{CS}, based on the zeroCorrelationZoneConfig parameter. At 710, the UE may generate M preambles based on L_{RA}, N_{CS}, and u. At 712, the UE may group the M preambles according to M/(2^{size(n1IDUE)}. At 714, the UE may select a preamble from one of the preamble groups corresponding to the received

$$n {1}_{UE}^{ID} .$$

In some implementations, the UE may group the M preambles according to a mapping provided in system information broadcast messages (e.g., SIB1) or prior signaling, which may also be based on a pre-configuration or UE-specific signaling from a previous connected state to the same base station or cell. Each preamble may be defined by a preamble ID, which in turn may be grouped under a preamble group ID for easier identification. Alternatively, the UE may perform the preamble grouping in a consecutive manner based on the number of generated preambles being less than or equal to the total of M possible preambles and the size of

$$n {1}_{UE}^{ID} .$$

In such cases, to select the preamble group, the UE may select the preamble group according to the received

$$n {1}_{UE}^{ID}$$

and the preamble group mapping, or the UE may randomly select a preamble group if

$$n {1}_{UE}^{ID}$$

is absent.

In some implementations, the UE may perform preamble group mapping according to one or more of the selected or received preamble sequence generated parameters, such as i, L_{RA}, N_{CS}, a cyclic shift, and u. In such cases, there may be a form of one or more sequence parameters mapping to a preamble group. In some cases, the preamble groups may be defined according to one or more of the indices received according to the PRACH-Configuration-Index IE. In some examples, the UE may transmit a preamble based on the preamble group mapping, which may be received by the NE as a configuration or generated by the UE according to some rules.

In some examples, a most significant bit (MSB) or a least significant bit (LSB) of

$$n {1}_{UE}^{ID}$$

may implicitly determine the UE group for a particular group of preamble transmissions, which in turn may help reduce the search space for which to perform desired correlations. The additional preambles may be quasi-orthogonal, which may result in non-zero cross-correlations. Additionally, or alternatively, the aspects of preamble generation based on a UE ID may extend to repetitions of the same preamble sequence or different preamble sequences. This may include various repetition types consisting of different time domain formats in which a sequence is repeated in terms of the CP, sequence, and guard period (GP). For example, formats such as CP|Sequence|Sequence|GP|, CP|Sequence|CP|Sequence|CP|GP|, CP|Sequence 1|CP|Sequence 2|CP|GP|, and so forth, may be supported.

As described herein, referencing Table 4, a UE may transmit the full (i.e., total) UE ID to an NE over three messages, where

$${n}_{UE}^{ID} = \{ Msg 1 ( n {1}_{UE}^{ID} ) + Msg 3 ( n {2}_{UE}^{ID} ) + Msg 5 ( n {3}_{UE}^{ID} ) \} .$$

For example, the UE may transmit the full UE ID over Message 1, a Message 3, and a Message 5 transmissions. The NE may derive the UE ID based on receiving the three messages, for example, if the UE has been registered on the PLMN. If the UE is unknown to the NE,

$${n}_{UE}^{ID}$$

may be based on a random n-bit ID, which may then be split up into

$$Msg 1 ( n {1}_{UE}^{ID} ) , Msg 3 ( n {2}_{UE}^{ID} ) and Msg 5 ( n {2}_{UE}^{ID} )$$

according to the specification or in an implementation-based manner. In some other implementations,

$${n}_{UE}^{ID}$$

may be split up into two messages transmitted in Message 1 and Message 3 or Message 1 and Message 5. That is, the UE may transmit at least two initial access messages during a RACH procedure, each message indicating at least a portion of the full UE ID. In such cases, the UE may transmit the preamble on a separate channel and transmit the UE ID components separately on the uplink data channel (e.g., a PUSCH), which may be in the form of control data or user data.

In some implementations, if the NE determines that a preamble group is overloaded or unbalanced based on a configured preamble group mapping and the received UE IDs

$$( e . g . , n {1}_{UE}^{ID} )$$

from all UEs performing initial access, the NE may make one or more additional adaptations, adjustments, or configuration updates via signaling to the one or more UEs. This may also be performed subject to an existing preamble configuration. For example, the NE may provide an updated UE IE

$$( e . g . , n {1}_{UE}^{ID} )$$

to a preamble group mapping, increase the size of

$$n {1}_{UE}^{ID}$$

to further filter out overlapping UEs, increase the number of preamble groups, or any combination thereof.

In some examples, the NE may provide further configuration guidance in terms of the selection criteria of preambles for UEs belonging to a particular preamble group. Such configuration guidance may be based on a variety of factors such as coverage, UE link quality, capacity considerations, UE quality of service (QoS) requirements, UE capability, UE device type, and so forth. Additionally, or alternatively, the UE may assign the UEs to each of the preamble groups in a deterministic manner, which may be specified or up to implementation (e.g., in a round-robin manner). Such method of assignment may also apply to CFRA, where the NE may assign preamble(s) to UEs, or when a UE's context is known in the RAN based on a previous connection to the same cell or a neighboring cell.

In some examples, the UE may perform UE ID-based preamble generation according to sequence-based spreading or cover-based sequences. In such cases,

$$n {1}_{UE}^{ID}$$

may be used to limit or reduce a search space of spreading-based or cover-based sequences such as OCC, m-sequence, P3 sequence, or any other preamble masking or spreading sequence. For example, if a preamble is based on a Zadoff-Chu sequence, depending on the UE grouping corresponding to

$$n {1}_{U E}^{ID} ,$$

the receiver may implicitly understand the subset of spreading sequences utilized over the total possible set of spreading sequences, which may result in a reduced search space for the UEs using the same preamble. The premise behind sequence-based spreading or cover code extensions is the element-wise multiplication of the Zadoff-Chu base sequence with cyclic shifts. For example, the original Zadoff-Chu sequence with a root index u and a cyclic shift v may be represented as x_{u,v}(n). Additionally, the p-length m-sequence may be represented by c_{w}[p], where w is an index. Then, the extended sequence may become x_{w,u,v}(n)=c_{w}[n]×x_{u,v}(n).

For an m-sequence spread Zadoff-Chu preamble, a maximum length sequence may be generated using linear feedback shift registers (LFSR) that implement linear recursion, which may be implemented to spread a preamble such as Zadoff-Chu to increase the preamble pool size. The sequence lengths supported may be restricted by 2^{m}−1. In such cases, the theoretical total preamble size may be M×p, which represents the full preamble search space (e.g., length-p m-sequence generates p={7, 15, 31, . . . } cover codes/spreading sequences, resulting in a theoretical preamble pool size of pM). Based on the n-bit

$$n {1}_{U E}^{ID} ,$$

the total search space may be divided according to

$$\frac{M \times p}{{2}^{n {1}_{U E}^{ID}}} ,$$

where if M=64, p=7, resulting in an exhaustive preamble pool size of 448 preambles. With the

$$n {1}_{U E}^{ID}$$

grouping, assuming

$$n {1}_{U E}^{ID} = 3$$

bits, the search space may be reduced to 56 preambles.

In some implementations, OCC may include a family of Hadamard binary cover codes used to orthogonalize sequences. Additionally, or alternatively, DFT-based OCC sequences, frequency-based cover codes, or time-based cover codes may be applied. For an OCC spread Zadoff-Chu preamble, a total preamble size may be M×q, which represents the full preambles search space (e.g., a length-q OCC generates {2, 4, 8, . . . } cover codes/spreading sequences, resulting in a theoretical preamble pool size of qM). Based on the n-bit

$$n {1}_{U E}^{ID} ,$$

the total search space may be divided according to

$$\frac{M \times q}{{2}^{n {1}_{U E}^{ID}}} ,$$

where if M=64, q=w, resulting in an exhaustive preamble pool size of 128 preambles. With the

$$n {1}_{U E}^{ID}$$

grouping, assuming

$$n {1}_{U E}^{ID} = 3$$

bits, the search space may be reduced to 16 preambles.

In some implementations, the P3 cover extension may be based on the Carlitz-Uchiyama bound, and is an algebraic-based cover extension. A P3 cover extension may be represented as

$${c}_{w , P 3} [ n ] = {e}^{- j π w \frac{{n}^{3}}{{L}_{R A}}} ,$$

0≤n≤L_{RA}−1, where w represents an integer with a value in the range 0≤n≤L_{RA}−1, where L_{RA} represents a sequence length. Then, for a P3-spread Zadoff-Chu preamble, the total preamble size may be M×L_{RA}, with a drastic increase in preamble pool size. However, such preambles may be quasi-orthogonal and require complex phase computation as opposed to basic element-wise binary multiplication. Based on the n-bit

$$n {1}_{U E}^{ID} ,$$

the total search space may be divided according to

$$\frac{M \times {L}_{RA}}{{2}^{n {1}_{U E}^{ID}}} ,$$

where if M=64, L_{RA}=139, resulting in an exhaustive preamble pool size of 8896 preambles. With the

$$n {1}_{U E}^{ID}$$

grouping, assuming

$$n {1}_{U E}^{ID} = 3$$

bits, the search space may be reduced to 1112 preambles, which is still quite large even for a short sequence length. As a result, longer UE IDs

$$n {1}_{U E}^{ID}$$

may be used to limit the search space even further.

In some implementations, the UE ID may, in part, be used to limit or reduce the search space of spreading-based or cover-based sequences, which may increase the overall preamble pool size from M total preambles to M+n total preambles due to the application of any one or more spreading-based or cover-based sequences. The UE ID may be used in part to form preamble groups from M+n total preambles and help reduce the blind detection burden at the receiver (e.g., at the NE or base station receiver). In some implementations, the average normalized cross-correlation performance and preamble pool size for each of the sequence-based or cover-based preamble designs described herein may vary for different values of L_{RA} and cyclic shift spacing N_{CS} derived from a zeroCorrelationZoneConfig parameter and a fixed root sequence. Due to the structure of the Zadoff-Chu sequence, L_{RA} and N_{CS} may play a role in the number of generated preambles that are quasi-orthogonal or orthogonal. In this way, the UE and the NE may coordinate regarding a preamble selection strategy to avoid collisions for large numbers of UEs with large preamble pool sizes.

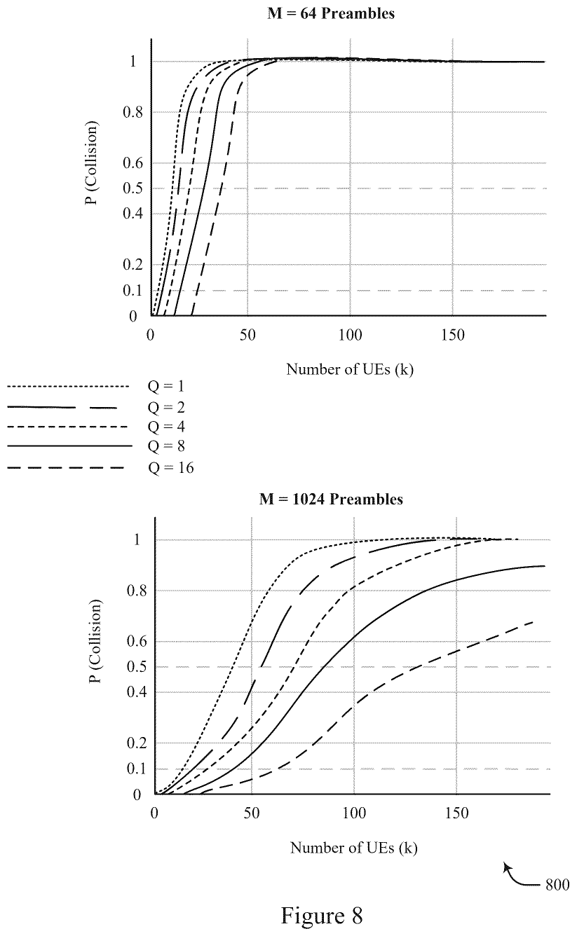

FIG. 8 illustrates an example of collision probabilities 800 in accordance with aspects of the present disclosure. The collision probabilities 800 depict the probability of collision (e.g., P(collision)) based on a number of UEs (i.e., users), k, and varying preamble pool sizes. In the example of FIG. 8, collision probabilities are shown for a total number of preambles M=64 and M=1024, though it should be noted that the probability of collision for k UEs may also be calculated for M=128 preambles, M=256 preambles, M=512 preambles, or another value of M. As described herein with reference to FIG. 7, an NE may deterministically group the UEs into desired Q preamble groups based on a received UE ID

$$( e . g . , n {1}_{U E}^{ID} )$$

or based on any other factors. In this example, the collision probability for k UEs for M=64 preambles and M=1024 preambles is depicted for Q=1, Q=2, Q=4, Q=8, and Q=16. As shown, the preamble group size allocation varies depending on k and the total number of preambles, M. For example, the probability of collision may decrease for higher values of Q as the total number of preambles M increases.

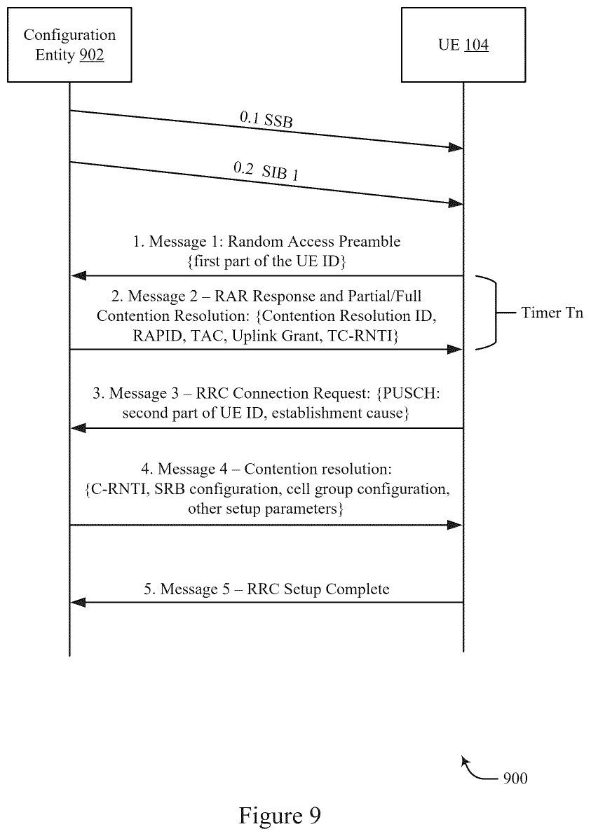

FIG. 9 illustrates an example of a process flow 900 in accordance with aspects of the present disclosure. The process flow 900 illustrates an example of a 4-step RACH procedure performed by a configuration entity 902 (e.g., an NE) and a UE 104 with partial or full contention resolution. In some implementations, the process flow 900 may support a timer, Tn, for the partial or full contention resolution in Message 2.

At step 0.1 in the example of FIG. 9, the UE 104 may receive an SSB from the configuration entity 902. For example, the SSB may be an SSB-MIB including minimum system information. At step 0.2, the UE 104 may receive an SIB1 from the configuration entity 902, for example, detailing the contents of the preamble configuration based on UE-IDs, preamble group mapping, sequence-spread/cover-based sequences, new preamble pool sizes or number of preambles, new contention resolution timers or random access response window configurations, and so forth. In some examples, the SIB1 may be an RMSI-SIB1.

At step 1, the UE 104 may transmit a Message 1 to the configuration entity 902. The Message 1 may include a sequence generated based on a first part or portion of a UE ID

$$( e . g . , a truncated version of the UE ID , n {1}_{U E}^{ID} )$$

In some examples, a timer for partial or full contention resolution, referred to herein as a partial/full contention resolution timer, may be defined to accommodate the configuration entity 902 to at least perform partial or full contention resolution based on a UE ID that is received or implicitly identified in a first message or preamble transmission (e.g., Message 1). That is, the partial/full contention resolution timer (or a timer Tn described below) may be initiated in response to transmission of the preamble in the Message 1. This implies that a subsequent RAR message (e.g., Message 2) aims to perform partial or full contention resolution.

At step 2, the UE 104 may receive a Message 2 from the configuration entity 902. The Message 2 may be an RAR for partial or full contention resolution, and may include at least one of a contention resolution ID, a RAPID, a TAC, an uplink grant, or a TC-RNTI. As described herein, partial or full contention resolution is performed when multiple UEs have selected a same preamble transmission, but a received UE ID,

$$n {1}_{U E}^{ID} ,$$

or an implicitly derived

$$n {1}_{U E}^{ID}$$

may be different. If the partial/full contention resolution timer expires, the UE 104 may trigger a new preamble transmission. The partial/full contention resolution timer may start earlier in the RACH procedure, for example, after the initial or preamble message transmission (e.g., Message 1) from the UE 104 to the configuration entity 902, which indicates the

$$n {1}_{U E}^{ID} .$$

The NE may configure the partial/full contention resolution timer via SIB messages (e.g., SIB-1) or UE-specific signaling (e.g., RRC signaling).

At step 3, the UE 104 may transmit a Message 3 to the configuration entity 902. The Message 3 may be an RRC connection request transmitted via a PUSCH. In some examples, the Message 3 may include at least a second part or portion of the UE ID

$$( e . g . , n {2}_{U E}^{ID} )$$

and an establishment cause. In some implementations, a RAR window duration or length and the partial/full contention resolution timer may be merged to form a singular timer, the timer Tn. That is, the timer Tn may be based on the duration of the RAR window and a duration of the partial/full contention resolution timer, where the duration of the timer Tn may be defined in terms of slots, subframes, frames, or other units of time. The UE 104 may receive the RAR (e.g., Message 2) according to the timer Tn, and the UE 104 may use the RAR to subsequently perform contention resolution. In some examples, the UE 104 may transmit one part of the UE ID

$$( e . g . , n {1}_{U E}^{ID} )$$

in a first message (e.g., Message 1) and a second part of the UE ID

$$( e . g . , n {2}_{U E}^{ID} )$$

in a third message (e.g., Message 3) of the 4-step RACH procedure. A time duration of the timer Tn may be defined on a symbol level, a slot level, a subframe level, a frame level, or another time bases (e.g., coordinated universal time (UTC), Global Navigation Satellite System (GNSS) time, etc.). In some examples, the timer Tn may also depend on a configured SCS or numerology, which may be configured by the received system information. In some examples, the timer Tn may be implemented as a time window, which may be associated with parameters such as a start time, an end time, a duration, a periodicity, and so forth.

At step 4, the UE 104 may receive a Message 4 from the configuration entity 902. The Message 4 may be another contention resolution message based on any partial contention resolution performed in step 2, which may include at least one of a C-RNTI, a TC-RNTI, an SRB configuration, a cell group configuration, or other setup parameters. In some examples, the contention resolution message may be a partial contention resolution message. The partial contention resolution message may indicate that the configuration entity 902 partially ascertains the UE ID from the Message 1. For example, if the Message 2 includes a contention resolution ID that is the same as the

$$n {1}_{U E}^{ID}$$

the UE 104 transmitted, then the UE 104 may understand that the contention has been resolved. In some examples, the UE 104 may monitor the control channel to receive a downlink control information (DCI) format transmission from the configuration entity 902 scrambled with an RNTI type within the timer Tn configured by an SIB (e.g., SIB-1) or UE-specific signaling (e.g., RRC signaling). The UE 104 may monitor a pre-defined search space for the DCI (e.g., a common search space). Alternatively, the contention resolution may be a full contention resolution message indicating that the configuration entity 902 fully ascertains the UE ID from the Message 1.

At step 5, the UE 104 may transmit a Message 5 to the configuration entity 902, where the Message 5 may be an RRC setup complete message indicating completion of the RACH procedure. In some cases, the timer Tn may stop when the contention is partially or fully resolved. For example, the timer Tn may stop when the UE 104 receives the second message, Message 2, scrambled by a UE-specific RNTI (e.g., an allocated TC-RNTI) or a C-RNTI of a fixed length (e.g., 16 or other x-bit value), and may be derived to form a subset of the UE ID

$$n {1}_{U E}^{ID}$$

$$( e . g . , a truncated version of {then}_{UE}^{ID} ) .$$

If the timer Tn expires, the RACH procedure may be deemed unsuccessful, the TC-RNTI may be discarded, the contention resolution in the second initial access message may be deemed to failed, and the corresponding medium access control (MAC) PDU may be discarded. In such cases, based on expiration of the timer Tn, the UE may retransmit the preamble or restart the initial access (e.g., the RACH procedure), where the retransmitted preamble may be based on a configured preamble group mapping. In some examples, a RAPID included in a MAC subheader may be derived from or based on the combination of a transmitted preamble ID and

$$n {1}_{U E}^{ID} .$$

If the contention is partially or fully resolved based on the described techniques, the UE may transmit a third message (e.g., Message 3). The Message 3 may be scrambled by the TC-RNTI and include

$$n {2}_{U E}^{ID}$$

in the contents of the message. The configuration entity 902 may successfully decode the Message 3 and receive the full UE ID,

$${n}_{UE}^{ID} ,$$

if

$${n}_{U E}^{ID} = \{ Msg 1 ( n {1}_{U E}^{ID} ) + Msg 3 ( n {2}_{U E}^{ID} ) \} .$$

In some examples, the UE may initiate one or more additional timers associated with one or more additional sequence-based or cover-based preamble transmission. The UE 104 may procedurally trigger such timers related to RRC establishment or connection requested procedures, for example, based on transmitting the Message 3. For example, such timers may include a T300 timer or a T301 timer, which the UE 104 may use to monitor the time it takes to establish an initial RRC connection with the network and during the RRC connection re-establishment procedure after multiple attempts. If the UE 104 transitions from an idle state (e.g., an RRC_IDLE state), the UE 104 may utilize such timers. However, if the UE 104 would like to resume a connection, for example from an inactive state (e.g., an RRC_INACTIVE state), the UE 104 may use a different timer such as a T319 timer.

In some examples, the Message 2 may include a valid C-RNTI as opposed to the TC-RNTI, once the configuration entity 902 is sure about the UE 104's identity based on the preamble transmission in Message 1. Whether the configuration entity 902 includes the C-RNTI or the TC-RNTI may also depend on a prior state of the UE 104 (e.g., RRC_IDLE or RRC_INACTIVE state), which implies a prior knowledge or stored context about the UE 104 in the CN or RAN in relation to the cell in which the UE 104 is attempting to perform initial access.

In some examples, the RAR window and the partial/full contention resolution timer may be defined for sequence-based or cover-based preamble transmissions. In such cases, the UE 104 may expect to wait for an allocated duration of the RAR window before triggering a preamble transmission. Enhancements to the RAR window and the partial/full contention resolution timer may be defined particularly in the context of time-based spreading or cover code applications of a preamble sequence. In the case of time-based spreading or a time-based cover code sequence that spans multiple symbols, the RAR window and the partial/full contention resolution timer may be adjusted (e.g., extended to have longer duration values), to account for the additional processing time and blind detection over the entire preamble search space. Existing specified RAR windows and partial/full contention resolution timers and new RAR windows and partial/full contention resolution timers may be applied to sequence-based and cover-based preamble transmissions. In some implementations, such RAR windows and partial/full contention resolution timers may account for a processing time for the initial and subsequent repetitions of the sequence-based and cover-based preamble transmissions.

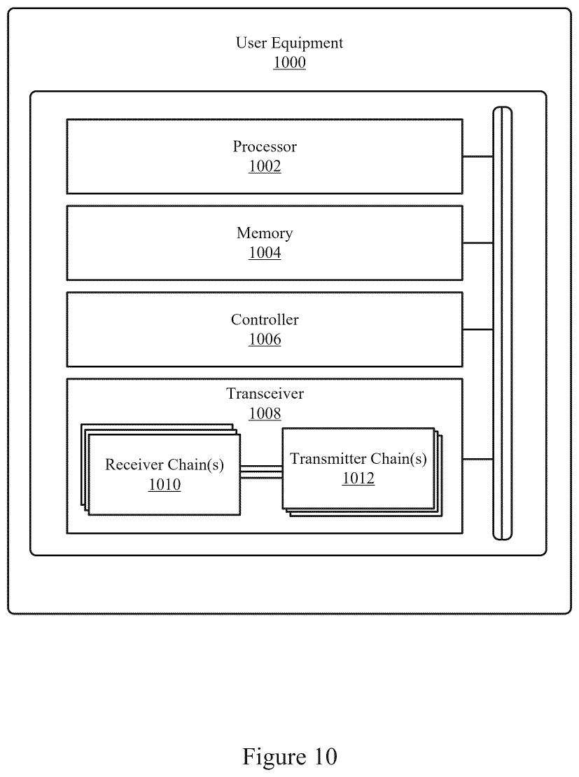

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving a PRACH preamble configuration including at a preamble sequence (e.g., a sequence-spread preamble sequence or a cover-based preamble sequence) and a timer configuration; initiating a timer based on the timer configuration; receiving a contention resolution message based on a UE ID corresponding to the UE; and performing contention resolution based on the contention resolution message, where the timer is stopped in response to successful completion of the contention resolution.

Additionally, the UE 1000 may be configured to support any one or combination of where a duration of the timer is based on at least one of a duration of a second timer or a duration of an RAR window, and where the duration of the timer is defined in slots, subframes, frames, or another time basis; transmitting a preamble, where the timer is initiated in response to transmission of the preamble; re-transmitting the preamble or restarting an initial access procedure based on expiration of the timer; where the preamble is transmitted based on a preamble group mapping; where the contention resolution message is a partial contention resolution message indicating that an NE partially ascertains the UE ID or a full contention resolution message indicating the NE fully ascertains the UE ID; where the contention resolution message indicates a TC-RNTI or a C-RNTI based on a truncated version of the UE ID; initiating one or more additional timers associated with one or more sequence-based or cover-based preamble transmissions; or where the preamble sequence includes a sequence-spread or cover-based preamble sequence, such as an m-sequence spread Zadoff-Chu sequence, a P3-sequence spread Zadoff-Chu sequence, or an OCC-spread Zadoff-Chu sequence.

Additionally, or alternatively, the UE 1000 may support at least one memory (e.g., the memory 1004) and at least one processor (e.g., the processor 1002) coupled with the at least one memory and configured to cause the UE to receive a PRACH preamble configuration including at least a preamble sequence and a timer configuration; initiate a timer based on the timer configuration; receive a contention resolution message based on a UE ID corresponding to the UE; and perform contention resolution based on the contention resolution message, where the timer is stopped in response to successful completion of the contention resolution.

Additionally, the UE 1000 may be configured to support any one or combination of where a duration of the timer is based on at least one of a duration of a second timer or a duration of an RAR window, and where the duration of the timer is defined in slots, subframes, frames, or another time basis; transmitting a preamble, where the timer is initiated in response to transmission of the preamble; re-transmitting the preamble or restarting an initial access procedure based on expiration of the timer; where the preamble is transmitted based on a preamble group mapping; where the contention resolution message is a partial contention resolution message indicating that an NE partially ascertains the UE ID or a full contention resolution message indicating the NE fully ascertains the UE ID; where the contention resolution message indicates a TC-RNTI or a C-RNTI based on a truncated version of the UE ID; initiating one or more additional timers associated with one or more sequence-based or cover-based preamble transmissions; or where the preamble sequence includes an m-sequence spread Zadoff-Chu sequence, a P3-sequence spread Zadoff-Chu sequence, or an OCC-spread Zadoff-Chu sequence.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

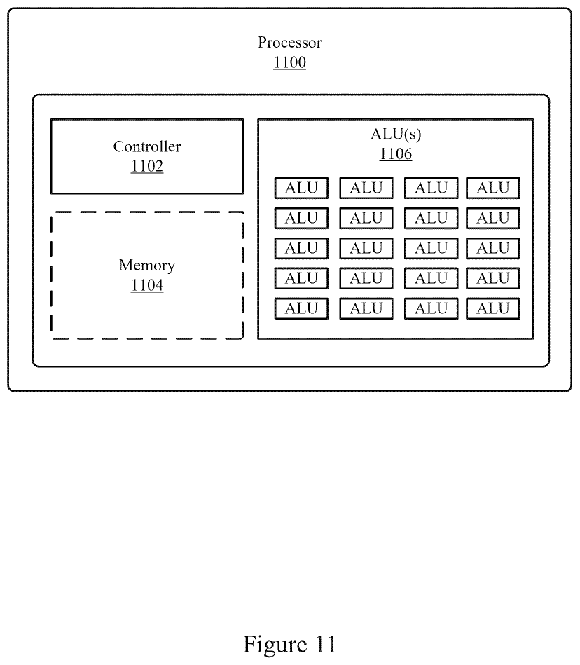

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a PRACH preamble configuration including at least a preamble sequence and a timer configuration; initiate a timer based on the timer configuration; receive a contention resolution message based on a UE ID corresponding to the UE; and perform contention resolution based on the contention resolution message, where the timer is stopped in response to successful completion of the contention resolution.

Additionally, the processor 1100 may be configured to or operable to support any one or combination of where a duration of the timer is based on at least one of a duration of a second timer or a duration of an RAR window, and where the duration of the timer is defined in slots, subframes, frames, or another time basis; transmitting a preamble, where the timer is initiated in response to transmission of the preamble; re-transmitting the preamble or restarting an initial access procedure based on expiration of the timer; where the preamble is transmitted based on a preamble group mapping; where the contention resolution message is a partial contention resolution message indicating that an NE partially ascertains the UE ID or a full contention resolution message indicating the NE fully ascertains the UE ID; where the contention resolution message indicates a TC-RNTI or a C-RNTI based on a truncated version of the UE ID; initiating one or more additional timers associated with one or more sequence-based or cover-based preamble transmissions; or where the preamble sequence includes an m-sequence spread Zadoff-Chu sequence, a P3-sequence spread Zadoff-Chu sequence, or an OCC-spread Zadoff-Chu sequence.

Additionally, or alternatively, the processor 1100 may be configured to or operable to support at least one controller (e.g., the controller 1102) coupled with at least one memory (e.g., the memory 1104) and configured to cause the processor to transmit a PRACH preamble configuration including at least a preamble sequence and a timer configuration, where a timer is initiated based on the timer configuration; transmit a contention resolution message based on a UE ID; and perform contention resolution based on the contention resolution message, where the timer is stopped in response to successful completion of the contention resolution.

Additionally, the processor 1100 may be configured to or operable to support any one or combination of where a duration of the timer is based on at least one of a duration of a second timer or a duration of an RAR window, and where the duration of the timer is defined in slots, subframes, frames, or another time basis; receiving a preamble, where the timer is initiated in response to reception of the preamble; receiving a retransmission of the preamble based on expiration of the timer; where the preamble is received based on a preamble group mapping; where the contention resolution message is a partial contention resolution message indicating that the NE partially ascertains the UE ID or a full contention resolution message indicating the NE fully ascertains the UE ID; where the contention resolution message indicates a TC-RNTI or a C-RNTI based on a truncated version of the UE ID; where one or more additional timers are associated, the one or more additional timers associated with one or sequence-based or cover-based preamble transmissions; or where the preamble sequence includes an m-sequence spread Zadoff-Chu sequence, a P3-sequence spread Zadoff-Chu sequence, or an OCC-spread Zadoff-Chu sequence.

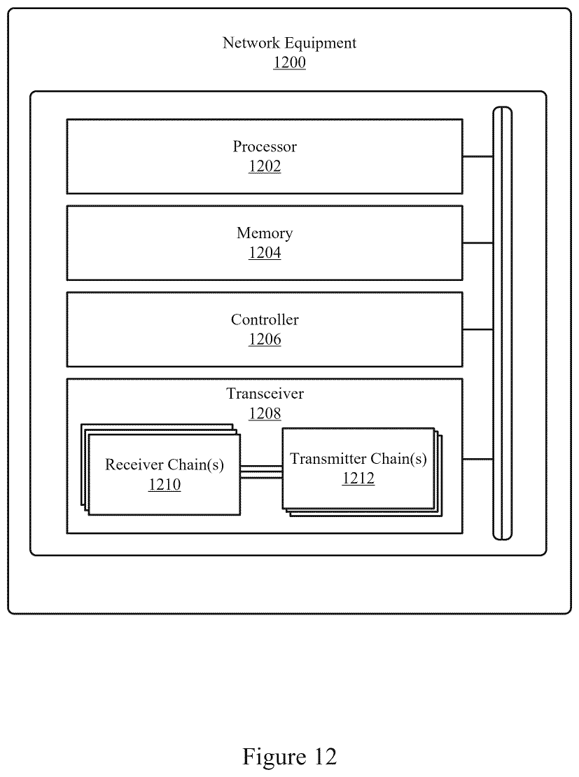

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting a PRACH preamble configuration including at least a preamble sequence and a timer configuration, where a timer is initiated based on the timer configuration; transmitting a contention resolution message based on a UE ID; and performing contention resolution based on the contention resolution message, where the timer is stopped in response to successful completion of the contention resolution

Additionally, the NE 1200 may be configured to or operable to support any one or combination of where a duration of the timer is based on at least one of a duration of a second timer or a duration of an RAR window, and where the duration of the timer is defined in slots, subframes, frames, or another time basis; receiving a preamble, where the timer is initiated in response to reception of the preamble; receiving a retransmission of the preamble based on expiration of the timer; where the preamble is received based on a preamble group mapping; where the contention resolution message is a partial contention resolution message indicating that the NE partially ascertains the UE ID or a full contention resolution message indicating the NE fully ascertains the UE ID; where the contention resolution message indicates a TC-RNTI or a C-RNTI based on a truncated version of the UE ID; where one or more additional timers are associated, the one or more additional timers associated with one or sequence-based or cover-based preamble transmissions; or where the preamble sequence includes an m-sequence spread Zadoff-Chu sequence, a P3-sequence spread Zadoff-Chu sequence, or an OCC-spread Zadoff-Chu sequence.

Additionally, or alternatively, the NE 1200 may support at least one memory (e.g., the memory 1204) and at least one processor (e.g., the processor 1202) coupled with the at least one memory and configured to cause the NE to transmit a PRACH preamble configuration including at least a preamble sequence and a timer configuration, where a timer is initiated based on the timer configuration; transmit a contention resolution message based on a UE ID; and perform contention resolution based on the contention resolution message, where the timer is stopped in response to successful completion of the contention resolution.

Additionally, the NE 1200 may be configured to support any one or combination of where a duration of the timer is based on at least one of a duration of a second timer or a duration of an RAR window, and where the duration of the timer is defined in slots, subframes, frames, or another time basis; receiving a preamble, where the timer is initiated in response to reception of the preamble; receiving a retransmission of the preamble based on expiration of the timer; where the preamble is received based on a preamble group mapping; where the contention resolution message is a partial contention resolution message indicating that the NE partially ascertains the UE ID or a full contention resolution message indicating the NE fully ascertains the UE ID; where the contention resolution message indicates a TC-RNTI or a C-RNTI based on a truncated version of the UE ID; where one or more additional timers are associated, the one or more additional timers associated with one or sequence-based or cover-based preamble transmissions; or where the preamble sequence includes an m-sequence spread Zadoff-Chu sequence, a P3-sequence spread Zadoff-Chu sequence, or an OCC-spread Zadoff-Chu sequence.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

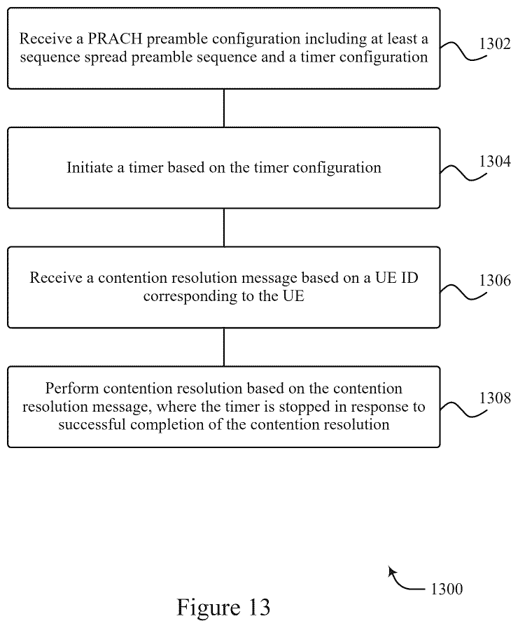

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving a PRACH preamble configuration including at least a preamble sequence and a timer configuration. The operations of 1302 may be performed in accordance with examples as described herein. In some implementations, aspects of the operations of 1302 may be performed by a UE as described with reference to FIG. 10.

At 1304, the method may include initiating a timer based on the timer configuration. The operations of 1304 may be performed in accordance with examples as described herein. In some implementations, aspects of the operations of 1304 may be performed by a UE as described with reference to FIG. 10.

At 1306, the method may include receiving a contention resolution message based on a UE ID corresponding to the UE. The operations of 1306 may be performed in accordance with examples as described herein. In some implementations, aspects of the operations of 1306 may be performed a UE as described with reference to FIG. 10.

At 1308, the method may include performing contention resolution based on the contention resolution message, where the timer is stopped in response to successful completion of the contention resolution. The operations of 1308 may be performed in accordance with examples as described herein. In some implementations, aspects of the operations of 1308 may be performed a UE as described with reference to FIG. 10.

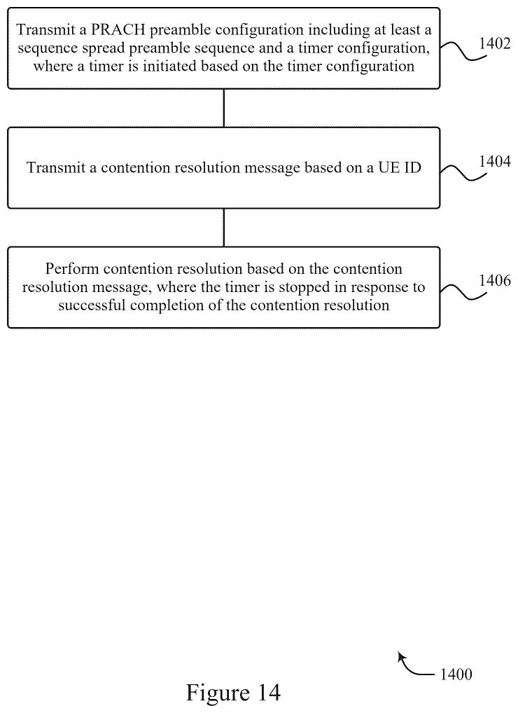

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting a PRACH preamble configuration including at least a preamble sequence and a timer configuration, where a timer is initiated based on the timer configuration. The operations of 1402 may be performed in accordance with examples as described herein. In some implementations, aspects of the operations of 1402 may be performed by an NE as described with reference to FIG. 12.

At 1404, the method may include transmitting a contention resolution message based on a UE ID. The operations of 1404 may be performed in accordance with examples as described herein. In some implementations, aspects of the operations of 1404 may be performed by an NE as described with reference to FIG. 12.

At 1406, the method may include performing contention resolution based on the contention resolution message, where the timer is stopped in response to successful completion of the contention resolution. The operations of 1406 may be performed in accordance with examples as described herein. In some implementations, aspects of the operations of 1406 may be performed by an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a physical random access channel (PRACH) preamble configuration comprising at least a preamble sequence and a timer configuration;
initiate a timer based at least in part on the timer configuration;
receive a contention resolution message based at least in part on a UE identifier (ID) corresponding to the UE; and
perform contention resolution based at least in part on the contention resolution message, wherein the timer is stopped in response to successful completion of the contention resolution.

2. The UE of claim 1, wherein a duration of the timer is based at least in part on at least one of a duration of a second timer or a duration of a random access response (RAR) window, and wherein the duration of the timer is defined in slots, subframes, frames, or another time basis.

3. The UE of claim 1, wherein the at least one processor is further operable to cause the UE to transmit a preamble, wherein the timer is initiated in response to transmission of the preamble.

4. The UE of claim 3, wherein the at least one processor is further operable to cause the UE to re-transmit the preamble or restart an initial access procedure based at least in part on expiration of the timer.

5. The UE of claim 4, wherein the preamble is transmitted based at least in part on a preamble group mapping.

6. The UE of claim 1, wherein the contention resolution message is a partial contention resolution message indicating that a network equipment (NE) partially ascertains the UE ID or a full contention resolution message indicating the NE fully ascertains the UE ID.

7. The UE of claim 1, wherein the contention resolution message indicates a temporary cell radio network temporary identifier (TC-RNTI) or a C-RNTI based at least in part on a truncated version of the UE ID.

8. The UE of claim 1, wherein the at least one processor is further operable to cause the UE to initiate one or more additional timers associated with one or more sequence-based or cover-based preamble transmissions.

9. The UE of claim 1, wherein the preamble sequence comprises an m-sequence spread Zadoff-Chu sequence, a third-order polynomial (P3)-sequence spread Zadoff-Chu sequence, or an orthogonal cover code (OCC)-spread Zadoff-Chu sequence.

10. A network equipment (NE) for wireless communication, comprising:
at least one memory; and
at least one processor coupled with the at least one memory and operable to cause the NE to:
transmit a physical random access channel (PRACH) preamble configuration comprising at least a preamble sequence and a timer configuration, wherein a timer is initiated based at least in part on the timer configuration;
transmit a contention resolution message based at least in part on a user equipment (UE) identifier (ID); and
perform contention resolution based at least in part on the contention resolution message, wherein the timer is stopped in response to successful completion of the contention resolution.

11. The NE of claim 10, wherein a duration of the timer is based at least in part on at least one of a duration of a second timer or a duration of a random access response (RAR) window, and wherein the duration of the timer is defined in slots, subframes, frames, or another time basis.

12. The NE of claim 10, wherein the at least one processor is further operable to cause the NE to receive a preamble, wherein the timer is initiated in response to reception of the preamble.

13. The NE of claim 12, wherein the at least one processor is further operable to cause the NE to receive a retransmission of the preamble based at least in part on expiration of the timer.

14. The NE of claim 13, wherein the preamble is received based at least in part on a preamble group mapping.

15. The NE of claim 10, wherein the contention resolution message is a partial contention resolution message indicating that the NE partially ascertains the UE ID or a full contention resolution message indicating the NE fully ascertains the UE ID.

16. The NE of claim 10, wherein the contention resolution message indicates a temporary cell radio network temporary identifier (TC-RNTI) or a C-RNTI based at least in part on a truncated version of the UE ID.

17. The NE of claim 10, wherein one or more additional timers are associated, the one or more additional timers associated with one or sequence-based or cover-based preamble transmissions.

18. The NE of claim 10, wherein the preamble sequence comprises an m-sequence spread Zadoff-Chu sequence, a third-order polynomial (P3)-sequence spread Zadoff-Chu sequence, or an orthogonal cover code (OCC)-spread Zadoff-Chu sequence.

19. A method performed by a user equipment (UE), the method comprising:
receiving a physical random access channel (PRACH) preamble configuration comprising at least a preamble sequence and a timer configuration;
initiating a timer based at least in part on the timer configuration;
receiving a contention resolution message based at least in part on a UE identifier (ID) corresponding to the UE; and
performing contention resolution based at least in part on the contention resolution message, wherein the timer is stopped in response to successful completion of the contention resolution.

20. A method performed by a network equipment (NE, the method comprising:
transmitting a physical random access channel (PRACH) preamble configuration comprising at least a preamble sequence and a timer configuration, wherein a timer is initiated based at least in part on the timer configuration;
transmitting a contention resolution message based at least in part on a user equipment (UE) identifier (ID); and
performing contention resolution based at least in part on the contention resolution message, wherein the timer is stopped in response to successful completion of the contention resolution.
